(19) United States
(12) Patent Application Publication
(10) Pub. No.: US 2004/0221616 A1
(43) Pub. Date: Nov. 11, 2004

(54) Continuous-treatment apparatus and continuous-treatment method

(76) Inventors: Shintaro Asuke, Suwa-shi (JP); Yoshiaki Mori, Nagano-ken (JP)

Correspondence Address: HARNESS, DICKEY & PIERCE, P.L.C., P.O. BOX 828, BLOOMFIELD HILLS, MI, 48303, US

(21) Appl. No.: 10/783,979

(22) Filed: Feb. 20, 2004

(30) Foreign Application Priority Data
Mar. 17, 2003 (JP) 2003-072230

(51) Int. Cl. C03B 25/00; B05D 3/02

(52) U.S. Cl. 65/118

(57) ABSTRACT

A continuous-treatment apparatus is provided which subjects a surface of an object, which is targeted for treatments, to continuous plural types of treatments, and is provided with an object carrier, which holds the object and carries the object along a carrying direction, and plural types of treatment units, which are arranged side by side along the carrying direction of the object and subject the object to sequential different treatments at atmospheric pressure or at a pressure near atmospheric pressure. The combination of the plural types of treatment units may be changed at will and any desired type of treatment unit may be added.

### RELATED APPLICATIONS

The present application claims priority to Japanese Patent Application No. 2003-072230 filed Mar. 17, 2003 which is hereby expressly incorporated by reference herein in its entirety.

### BACKGROUND OF THE INVENTION

1. Technical Field

The present invention relates to a continuous-treatment apparatus and a continuous-treatment method for subjecting a surface of an object, which is targeted for treatments, to continuous, desired plural types of treatments.

2. Background Art

Examples of objects to be treated include a raw glass plate used for a liquid crystal display element. This glass plate has been rapidly upsized with upsizing of the liquid crystal display element. Large scale processing and factories are required in order to subject large glass plates to various types of processing.

This type of known apparatus for manufacturing a liquid crystal device is used for selectively removing an orientation film and an insulating film from a terminal portion of the liquid crystal panel by forming a plasma while a mixed gas is supplied to the terminal portion.

### SUMMARY

A continuous-treatment apparatus of the present invention is a continuous-treatment apparatus for subjecting a surface of an object, which is targeted for treatments, to continuous plural types of treatments. The apparatus is provided with an object carrier for holding the above-described object and for carrying the above-described object along the carrying direction; and plural types of treatment units which are arranged side by side along the above-described carrying direction of the above-described object and which subject the above-described object to sequential different treatments at atmospheric pressure or at a pressure near atmospheric pressure, wherein the combination of the above-described plural types of treatment units may be changed at will and any desired type may be added.

According to such a configuration, the object carrier can hold the object and carry the object along the carrying direction.

The plural types of treatment units are arranged side by side along the carrying direction of the object. The plural types of treatment units subject the object to sequential different treatments at atmospheric pressure or at a pressure near atmospheric pressure. The combination of the above-described plural types of treatment units may be changed at will and any desired type may be added. At this time, the surface of the object, which is targeted for treatments, may be in a condition facing upward or downward.

In this manner, since the combination of the above-described plural types of treatment units can be changed or any type can be added, when the surface of the object, which is targeted for treatments, is subjected to plural types of treatments, required changes in the combination of the plural types of treatments or the addition of any desired type can be performed. Consequently, the continuous-treatment apparatus can simply and reliably change the manner of continuous treatments in accordance with the type of object.

In the above-described configuration, desirably, the above-described object carrier is provided with a suction portion for removably suctioning and holding the surface targeted for holding, which is opposite to the above-described surface targeted for treatments, of the above-described object, a guide component for guiding the above-described suction portion in the above-described carrying direction, and a driving portion for transferring the above-described suction portion along the above-described guide component.

According to such a configuration, the suction portion removably suctions and holds the surface targeted for holding, which is opposite to the surface targeted for treatments, of the object. The guide component guides the suction portion in the carrying direction. The driving portion transfers the suction portion along this guide component.

In this manner, the object is reliably transferred by the driving portion in the carrying direction along the guide component while being suctioned by the suction portion.

In the above-described configuration, desirably, the above-described object is carried by the above-described object carrier while the above-described surface targeted for treatments is facing downward, and the above-described plural types of treatment units are operated upward to treat the above-described surface, which is targeted for treatments, of the above-described object.

According to such a configuration, the plural types of treatment units are operated upward to treat the surface of the object which is targeted for treatments.

In this manner, even when a liquid agent is used for treating the surface targeted for treatments, excess liquid agent is allowed to fall by gravitation from the surface targeted for treatments. Consequently, the amount of remaining excess liquid used for treatment can be reduced and, therefore, the liquid has no negative effect on a downstream treatment.

Furthermore, the adhesion of particles to the surface targeted for treatments can be reduced. The surface targeted for treatments can be subjected to a liquid agent treatment by slit coating through the use of capillarity.

In the above-described configuration, desirably, the above-described plural types of treatment units include a cleaning treatment unit, a drying treatment unit, a surface modification treatment unit, a liquid agent application treatment unit, and an annealing treatment unit.

According to such a configuration, the surface of the object, which is targeted for treatments, can be subjected to the cleaning, drying, surface modification, liquid agent application, and annealing treatments.

In the above-described configuration, desirably, the above-described object is a substrate of a display device.

According to such a configuration, the object is the substrate of the display device. The surface, which is targeted for treatments, of the substrate of this display device can be subjected to continuous plural types of treatments.

A continuous-treatment method of the present invention is a continuous-treatment method for subjecting a surface of an object, targeted for treatments, to continuous plural types of treatments. The method includes the step of subjecting the above-described object to sequential different treatments at atmospheric pressure or at a pressure near atmospheric pressure through the use of plural types of treatment units arranged side by side along the carrying direction of the above-described object while the above-described object is held and the above-described object is carried along the above-described carrying direction, wherein the combination of the above-described plural types of treatment units may be changed at will and any desired type may be added in accordance with the type of the above-described object.

According to such a configuration, the object carrier can hold the object and carry the object along the carrying direction.

The plural types of treatment units are arranged side by side along the carrying direction of the object. The plural types of treatment units subject the object to sequential different treatments at atmospheric pressure or at a pressure near atmospheric pressure. The combination of the above-described plural types of treatment units may be changed at will and any desired type may be added. At this time, the surface of the object, which is targeted for treatments, may be in a condition facing upward or downward.

In this manner, since the combination of the plural types of treatment units can be changed or any type can be added, when the surface of the object, which is targeted for treatments, is subjected to plural types of treatments, a required change in the combination of the plural types of treatments or the addition of any desired type can be performed. Consequently, the continuous-treatment apparatus can simply and reliably change the manner of continuous treatments in accordance with the type of object.

In the above-described configuration, desirably, the above-described object is carried by the above-described object carrier while the above-described surface targeted for treatments is facing downward, and the above-described plural types of treatment units are operated upward to treat the above-described surface of the above-described object, which is targeted for treatments.

According to such a configuration, the plural types of treatment units are operated upward to treat the surface of the object, which is targeted for treatments.

In this manner, even when a liquid agent is used for treating the surface targeted for treatments, excess liquid agent is allowed to fall by gravitation from the surface targeted for treatments. Consequently, the amount of remaining excess liquid used for treatment can be reduced and, therefore, the liquid has no negative effect on a downstream treatment.

Furthermore, the adhesion of particles to the surface targeted for treatments can be reduced. The surface targeted for treatments can be subjected to a liquid agent treatment by slit coating through the use of capillarity.

In the above-described configuration, desirably, the above-described plural types of treatment units include a cleaning treatment unit, a drying treatment unit, a surface modification treatment unit, a liquid agent application treatment unit, and an annealing treatment unit.

According to such a configuration, the surface of the object, which is targeted for treatments, can be subjected to the cleaning, drying, surface modification, liquid agent application, and annealing treatments.

### BRIEF DESCRIPTION OF THE DRAWINGS

FIG. 1 is a diagram showing a first embodiment of a continuous-treatment apparatus of the present invention.

FIG. 2 is a diagram showing an example of a cleaning treatment unit shown in FIG. 1.

FIG. 3 is a diagram showing an example of a drying treatment unit shown in FIG. 1.

FIG. 4 is a diagram showing an example of a lyophilic treatment unit shown in FIG. 1.

FIG. 5 is a diagram showing an example of a liquid-repellency treatment unit shown in FIG. 1.

FIG. 6 is a diagram showing an example of a liquid agent application treatment unit shown in FIG. 1.

FIG. 7 is a diagram showing an example of a continuous-treatment method of the present invention.

FIG. 8 is a diagram showing examples of plural types of processes with respect to the object of the present invention.

FIG. 9 is a diagram showing a part of an example of a liquid crystal display device including the object.

FIG. 10 is a diagram showing a second embodiment of the continuous-treatment apparatus of the present invention.

### DETAILED DESCRIPTION

Preferred embodiments of the present invention will be described below with reference to the drawings.

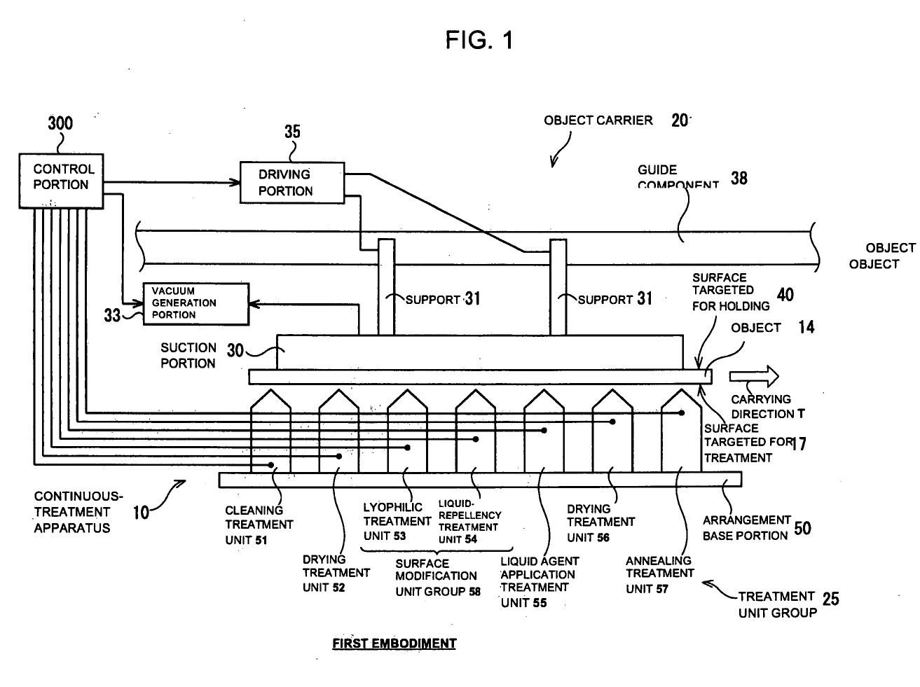

FIG. 1 shows a preferred embodiment of a continuous-treatment apparatus of the present invention.

The continuous-treatment apparatus 10 shown in FIG. 1 includes an object carrier 20 and a treatment unit group 25.

The continuous-treatment apparatus 10 is an apparatus for subjecting a surface 17, which is targeted for treatments, of an object 14 to continuous plural types of treatments which can be combined at will.

The object carrier 20 of the continuous-treatment apparatus 10 will now be described.

The object carrier 20 shown in FIG. 1 is a device for carrying the object 14 along a carrying direction T while suctioning a surface 40, which is targeted for holding, of the object 14.

The object carrier 20 includes a suction portion 30, supports 31, a vacuum generation portion 33, a driving portion 35, and a guide component 38.

The suction portion 30 is a portion for removably suctioning the surface 40, which is targeted for holding, of the object 14. This suction portion 30 is connected to the vacuum generation portion 33. When the vacuum generation portion 33 is operated, the suction portion 30 removably vacuum-suctions the surface 40, which is targeted for holding, of the object 14. When the operation of the vacuum generation portion 33 is stopped, the surface 40 targeted for holding is released from the suction portion 30 and can be removed.

The supports 31 hold the suction portion 30 so that the suction portion 30 is suspended from the guide component 38. The guide component 38 is fixed in the direction parallel to the carrying direction T.

The driving portion 35 is an actuator, such as an electric motor, for transferring the supports 31 in the carrying direction T along the guide component 38.

In this manner, when the driving portion 35 is operated, the suction portion 30 can be linearly transferred in the carrying direction T along the guide component 38.

Next, an example of the object 14 will be described.

The object 14 is a glass plate used for a large liquid crystal display element, for example. With respect to the size, the object 14 is, for example, a large substrate having at least one of the vertical length and the horizontal length of at least 1.5 m.

The surface 17, which is targeted for treatments, of this object 14 is a surface opposite to the surface 40 targeted for holding, and is held in order to face downward. This surface 17 targeted for treatments can be subjected to continuous plural types of treatments which can be combined at will by the use of the treatment unit group 25.

The treatment unit group 25 shown in FIG. 1 will now be described below.

The treatment unit group 25 includes an arrangement base portion 50 and plural types of treatment units. The plural types of treatment units shown in FIG. 1 include a cleaning treatment unit 51, a drying treatment unit 52, a lyophilic treatment unit 53, a liquid-repellency treatment unit 54, a liquid agent application treatment unit 55, a drying treatment unit 56, and an annealing treatment unit 57.

The cleaning treatment unit 51, the drying treatment unit 52, the lyophilic treatment unit 53, the liquid-repellency treatment unit 54, the liquid agent application treatment unit 55, the drying treatment unit 56, and the annealing treatment unit 57 are arranged in that order along the carrying direction T on the arrangement base portion 50.

The cleaning treatment unit 51, the drying treatment unit 52, the lyophilic treatment unit 53, the liquid-repellency treatment unit 54, the liquid agent application treatment unit 55, the drying treatment unit 56, and the annealing treatment unit 57 are characterized in that the order of arrangement thereof can be changed, some treatment units can be replaced with other treatment units, and/or any other treatment unit can be added on the arrangement base portion 50.

For example, in FIG. 1, the lyophilic treatment unit 53 and the liquid-repellency treatment unit 54 constitute a surface modification unit group 58. However, the order of the lyophilic treatment unit 53 and the liquid-repellency treatment unit 54 may be interchanged. That is, the liquid-repellency treatment unit 54 is located upstream relative to the carrying direction T and the lyophilic treatment unit 53 is located downstream relative to the carrying direction T.

In any event, the order of the treatments performed with the cleaning treatment unit 51, the drying treatment unit 52, the lyophilic treatment unit 53, the liquid-repellency treatment unit 54, the liquid agent application treatment unit 55, the drying treatment unit 56, and the annealing treatment unit 57 for the surface 17 targeted for treatments carried in the carrying direction T may be changed.

In a first embodiment of the present invention, the cleaning treatment unit 51, the drying treatment unit 52, the lyophilic treatment unit 53, the liquid-repellency treatment unit 54, the liquid agent application treatment unit 55, the drying treatment unit 56, and the annealing treatment unit 57 are located below the surface 17 targeted for treatments.

Since each of the units 51 to 57 is located below the surface 17 targeted for treatments, for example, in the case where a liquid agent is supplied by blowing onto the surface 17 targeted for treatments, an excess liquid agent on the surface 17 targeted for treatments falls by gravitation from the surface 17 targeted for treatments. Consequently, the amount of remaining excess liquid can be reduced and the fallen liquid agent can be intensively recovered. Furthermore, since the amount of remaining excess liquid is reduced or is eliminated, the liquid has no negative effect on a predetermined treatment performed with a downstream unit.

In addition, the adherence of particles to the surface targeted for treatments can be reduced. The surface targeted for treatments can be subjected to a liquid agent treatment by slit coating through the use of capillarity.

A specific example of the structure of each of the cleaning treatment unit 51., the drying treatment unit 52, the lyophilic treatment unit 53, the liquid-repellency treatment unit 54, the liquid agent application treatment unit 55, the drying treatment unit 56, and the annealing treatment unit 57 will now be described below.

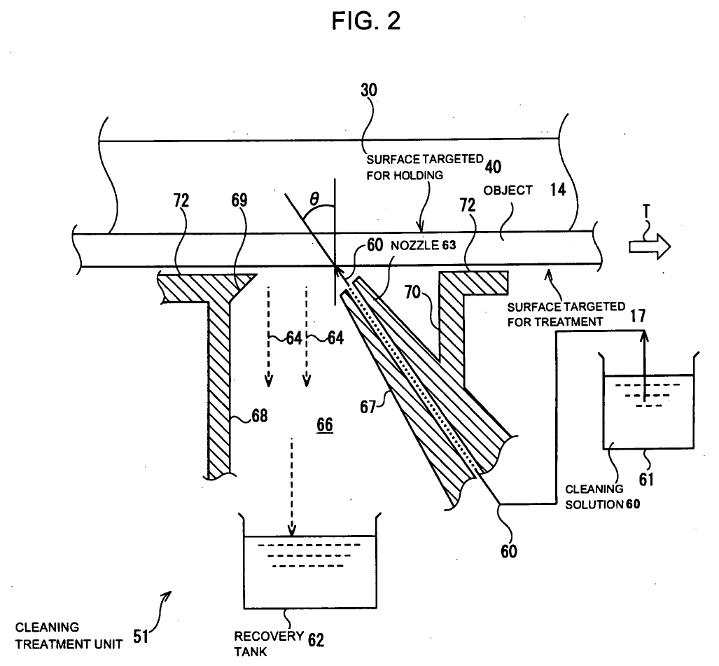

FIG. 2 shows a specific example of the structure of the cleaning treatment unit 51 shown in FIG. 1.

The cleaning treatment unit 51 is a device for cleaning the surface 17 targeted for treatments by supplying a cleaning solution 60 to the surface 17, which is targeted for treatments, of the object 14. The cleaning solution 60 is contained in a tank 61. The cleaning solution 60 in the tank 61 is blown onto the surface 17 targeted for treatments through a nozzle 63 at, for example, an injection angle of θ as indicated by an arrow 60′. The angle θ is an angle smaller than 45 degrees, for example.

The blown cleaning solution 60 falls as indicated by broken line arrows 64, and is recovered into a recovery tank 62. This cleaning solution 60 is blown onto the surface 17 targeted for treatments and, thereafter, is recovered into the recovery tank 62 through a recovery path 66 because of falling by gravitation.

This recovery path 66 is composed of an inclined end surface 67 and an opposite surface 68. This opposite surface 68 has an inclined surface 69 in the vicinity of (near) the surface 17 targeted for treatments. In this manner, the cleaning solution injected from the nozzle 63 cleans the surface 17 targeted for treatments and, thereafter, the remaining excess cleaning solution 60 can be reliably recovered into the recovery tank 62. The nozzle 63 has an opposite surface 70. Since this opposite surface 70 is provided, the cleaning solution 60 injected from the nozzle 63 is prevented from leaking outside the recovery path 66. A top end surface 72 constituting the recovery path 66 is disposed with a predetermined gap from the surface 17 targeted for treatments.

The cleaning solution 60 falls through the recovery path 66 as indicated by broken line arrows 64. When this recovery path 66 is configured to be evacuated to a negative pressure, leakage of the cleaning solution 60 in the forward or backward direction with respect to the carrying direction (traveling direction) T can be prevented or reduced.

The drying treatment unit 52 shown in FIG. 1 will now be described below.

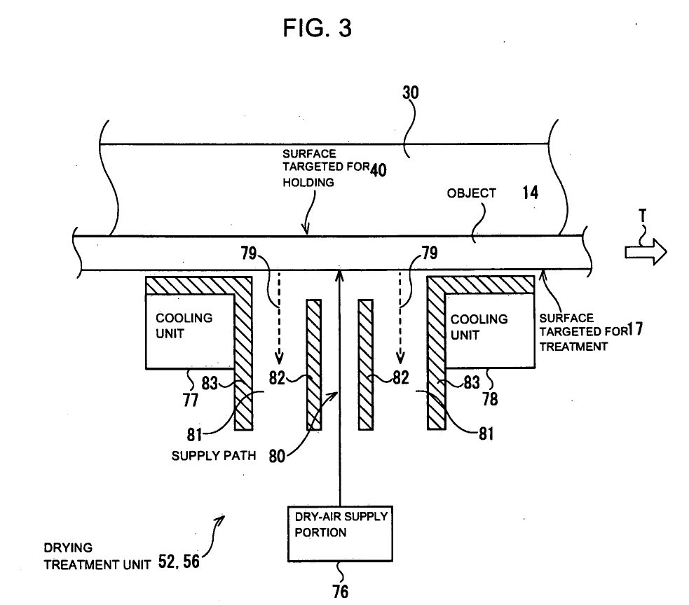

An example of the structure of the drying treatment unit 52 is shown in FIG. 3. The drying treatment unit 52 includes a dry-air supply portion 76 and cooling units 77 and 78. The dry-air supply portion 76 blows dry air directly onto the surface 17 targeted for treatments, through the supply path 80. The blown dry air dries the surface 17 targeted for treatments and, thereafter, is guided to the recovery paths 81 along the direction indicated by broken line arrows 79, that is, in the downward direction, so as to be recovered.

Wall portions 82 constitute the supply path 80. Side walls 83 constitute the recovery paths 81. The side walls 83 are provided with respective cooling units 77 and 78. The cooling unit 77 is located on the upstream side with respect to the carrying direction T, and the cooling unit 78 is located on the downstream side. In this manner, the cooling units cool the side walls 83 and, thereby, residual heat of the side walls 83 is prevented from applying excess heat to the surface 17 targeted for treatments.

In place of the dry-air supply portion 76, the supply path 80, and the recovery paths 81, the following configuration may be adopted. That is, for example, a heating wire for heat generation may be disposed to face the surface 17 targeted for treatments, and this heating wire may heat the surface 17 targeted for treatments.

The lyophilic treatment unit 53 and the liquid-repellency treatment unit 54 shown in FIG. 1 will now be described below.

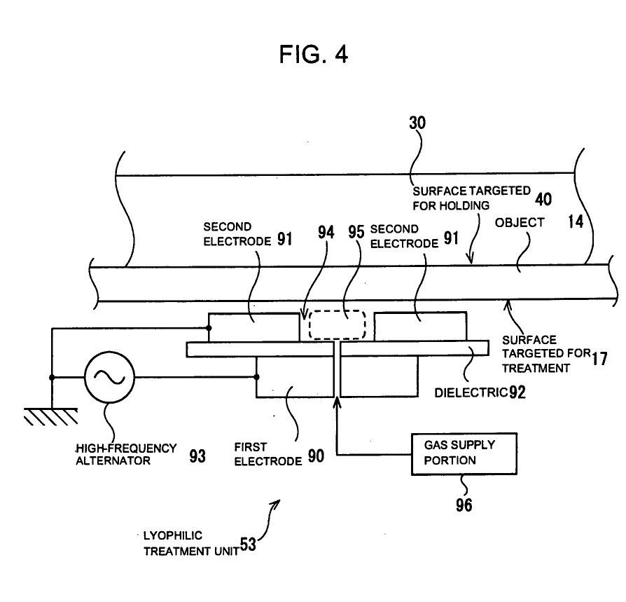

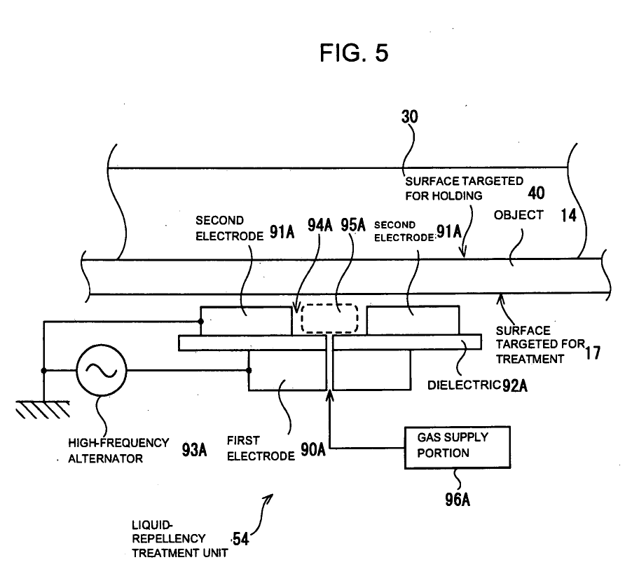

FIG. 4 shows a specific example of the structure of the lyophilic treatment unit 53, and FIG. 5 shows a specific example of the liquid-repellency treatment unit 54.

The lyophilic treatment unit 53 and the liquid-repellency treatment unit 54 are so-called atmospheric-pressure plasma treatment apparatuses having the same structure.

The atmospheric-pressure plasma treatment apparatus generates a plasma discharge region at atmospheric pressure or at a pressure near atmospheric pressure. In this plasma discharge region, since excited active species of the treatment gas (which may be referred to as reactant gas) are generated, the surface 17, which is targeted for treatments, of the object 14 can be subjected to the lyophilic treatment or the liquid-repellency treatment with the excited active species.

The lyophilic treatment unit 53 shown in FIG. 4 will now be described.

The lyophilic treatment unit 53 is a device for subjecting the surface 17 targeted for treatments located on the bottom side of the object 14 to lyophilic treatment.

The lyophilic treatment unit 53 includes a first electrode 90, a second electrode 91, and a dielectric 92. The first electrode 90 is connected to a high-frequency alternator 93. The high-frequency alternator 93 is grounded. The second electrode 91 is grounded. The dielectric 92 is disposed between the first electrode 90 and the second electrode 91.

The second electrode 91 has an opening 94. A plasma discharge region 95 can be provided inside opening 94, as indicated by a broken line, by creeping discharge of the second electrode 91. A mixed gas is supplied from a gas supply portion 96 to this plasma discharge region 95. The mixed gas is a mixture of a carrier gas and a reactant gas. The carrier gas is He, for example, and the reactant gas is O₂. In this manner, excited active species of the reactant gas are generated in the plasma discharge region 95. The surface 17 targeted for treatments is subjected to the lyophilic treatment by the excited active species, and is imparted with lyophilicity.

The liquid-repellency treatment unit 54 shown in FIG. 5 has the same structure as that of the lyophilic treatment unit 53 shown in FIG. 4, and the operations are the same as well. The liquid-repellency treatment unit 54 includes a first electrode 90A, a second electrode 91A, a dielectric 92A, and a high-frequency alternator 93A. A plasma discharge region 95A is provided inside an opening 94A of the second electrode 91A, as indicated by a broken line, by creeping discharge of the second electrode 91A. A mixed gas is supplied from a gas supply portion 96A to this plasma discharge region 95A. A carrier gas in the mixed gas is He, for example, and the reactant gas is CF₄.

In this manner, excited active species of the reactant gas are generated in the plasma discharge region 95A. The surface 17 targeted for treatments is subjected to the liquid-repellency treatment by the excited active species, and is imparted with liquid repellency.

The lyophilic treatment unit 53 and the liquid-repellency treatment unit 54 shown in FIG. 4 and FIG. 5, respectively, can generate plasma discharge regions at atmospheric pressure or at a pressure near atmospheric pressure, and have simple structures.

The liquid agent application treatment unit 55 will now be described below.

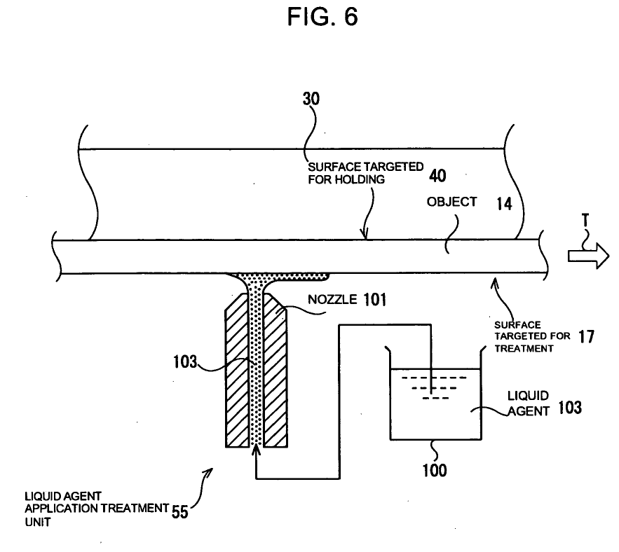

FIG. 6 shows a specific example of the structure of the liquid agent application treatment unit 55.

The liquid agent application treatment unit 55 includes a tank 100 and a nozzle 101. A liquid agent 103 is contained in the tank 100. This liquid agent 103 is supplied to the nozzle 101 and, thereby, is supplied to the surface 17, which is targeted for treatments, of the object 14. The end of nozzle 101 is disposed with a predetermined gap from the surface 17 targeted for treatments. The liquid agent 103 is applied upward from nozzle 101 through the use of so-called capillarity against the gravitation and adheres to the surface 17 targeted for treatments.

That is, the surface 17, which is targeted for treatments, of the object 14 is facing downward and, therefore, there is a benefit in that the above-described application system can be used. If the surface 17 targeted for treatments is facing upward, adoption of this application system is difficult. The application system of the liquid agent through the use of nozzle 101 is referred to as slit coating or the like.

By using such a nozzle 101, the liquid agent 103 is allowed to adhere only to the lyophilic portion treated by the lyophilic treatment unit 53. That is, the liquid is only allowed to be applied to a portion subjected to the lyophilic treatment in a very small region through the use of the adsorption force of the surface 17 targeted for treatments and the capillarity of the nozzle 101.

A control portion 300 shown in FIG. 1 can control the operation of each of the driving portion 35, the vacuum generation portion 33, the cleaning treatment unit 51, the drying treatment unit 52, the lyophilic treatment unit 53, the liquid-repellency treatment unit 54, the liquid agent application treatment unit 55, the drying treatment unit 56, and the annealing treatment unit 57.

Next, an example of a continuous-treatment method for subjecting the surface 17, which is targeted for treatments, of the object 14 to continuous, desired plural types of treatments with the continuous-treatment apparatus 10 shown in FIG. 1 will be described.

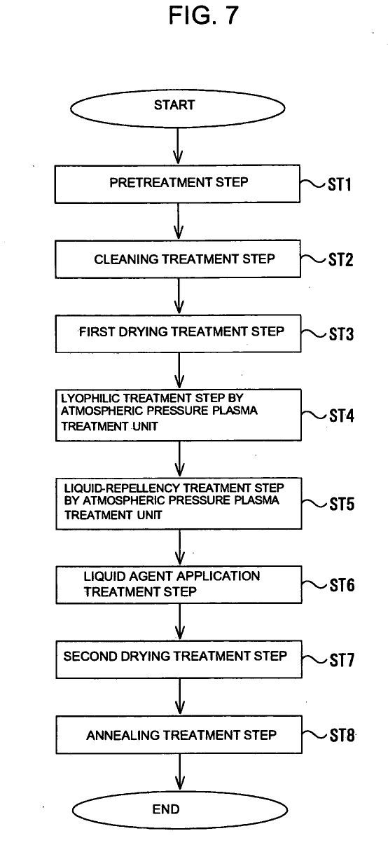

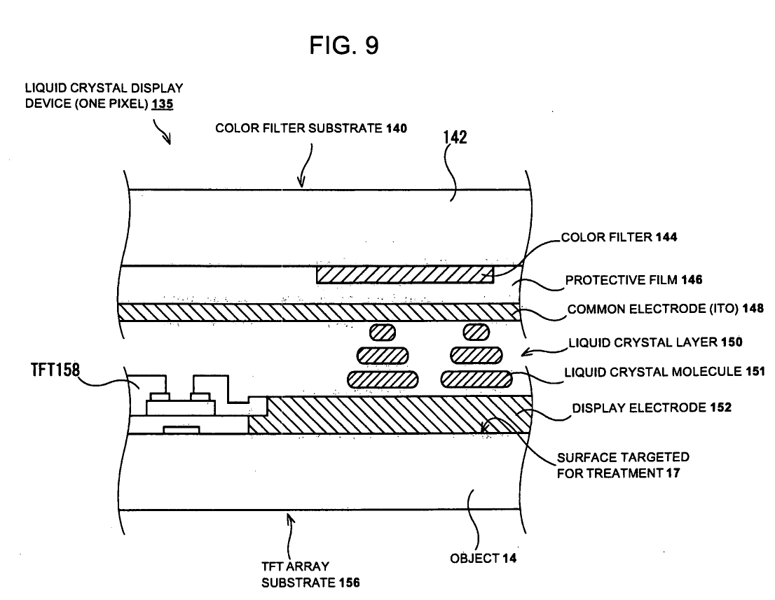

FIG. 7 is a flow diagram showing an example of the continuous-treatment method. A specific example of the object 14 will be described prior to the continuous-treatment method. The object 14 is a glass plate constituting a liquid crystal display device (which may be referred to as a liquid crystal display element) shown in FIG. 9.

The liquid crystal display device 135 shown in FIG. 9 indicates a so-called one pixel. Here, an example of the structure of the liquid crystal display device 135 will be briefly described.

The liquid crystal display device 135 includes a TFT array substrate 156, a color filter substrate 140, and a liquid crystal layer 150. In the TFT array substrate 156, a TFT 158, which is a switching element for driving a liquid crystal, and a display electrode 152 are provided on the surface 17, which is targeted for treatments, of the object 14 provided as a glass substrate.

The color filter substrate 140 has a configuration in which a color filter 144 and a protective layer 146 are provided on a glass substrate 142. A common electrode 148 is provided on the protective layer 146.

The TFT array substrate 156 and the color filter substrate 140 are bonded to each other with a sealing element and, thereafter, a liquid crystal is injected in the space between the two, so that the liquid crystal display device 135 shown in FIG. 9 is formed. A voltage is applied between the display electrode 152 and the common electrode 148. In this manner, rearrangement of liquid crystal molecules 151 occurs and, thereby, light is transmitted or intercepted. This operation is performed with respect to each pixel of the liquid crystal display device 135, so that the liquid crystal display device can display images.

A coating of ITO (Indium Tin Oxide), which is a transparent conductive film, is used for the display electrode 152 and the common electrode 148.

The continuous-treatment method for subjecting the surface 17, which is targeted for treatments, of the object 14 shown in FIG. 1 to continuous, desired plural types of treatments is now described with reference to the flow diagram shown in FIG. 7.

The flow diagram shown in FIG. 7 includes steps from a pretreatment step ST1 to an annealing treatment step ST8.

In the pretreatment step ST1, a lyophilic and liquid-repellency treatment pattern for performing the lyophilic treatment and the liquid-repellency treatment, described below, is formed on the surface 17 targeted for treatments by forming a pattern formation film (for example, a photoresist film) from a photosensitive resin.

Subsequently, steps from a cleaning treatment step ST2 to the annealing treatment step ST8 are performed as shown in FIG. 7.

The object 14 shown in FIG. 1 is held by being vacuum-suctioned with the suction portion 30. The driving portion 35 is operated and, thereby, the object 14 and the suction portion 30 are carried in the carrying direction T along the guide component 38.

In this case, the surface 40, which is targeted for holding, of the object 14 is suctioned by the suction portion 30 so that the surface 17 targeted for treatments faces downward. Consequently, the surface 17 targeted for treatments faces the side of the treatment unit group 25. Each of the treatment units 51 to 57 of the treatment unit group 25 can be operated upward to independently treat the surface 17 targeted for treatments.

Each of the treatment units 51 to 57 of the treatment unit group 25 is removably arranged in a line on the arrangement base 50.

In the example shown in FIG. 1, the lyophilic treatment unit 53 is located upstream from the liquid-repellency treatment unit 54. The drying treatment unit 52 is arranged between the cleaning treatment unit 51 and the lyophilic treatment unit 53. The lyophilic treatment unit 53 and the liquid-repellency treatment unit 54 are atmospheric-pressure plasma treatment units. The liquid agent application treatment unit 55 is located downstream from the liquid-repellency treatment unit 54. The drying treatment unit 56 is disposed between the liquid agent application treatment unit 55 and the annealing treatment unit 57. The drying treatment unit 56 and the drying treatment unit 52 may adopt the same structure shown in FIG. 3.

In the cleaning treatment step ST2 shown in FIG. 7, the cleaning solution 60 is injected from the nozzle 63 to the surface 17 targeted for treatments, as shown in FIG. 2. The surface 17 targeted for treatments is thereby cleaned by the cleaning solution 60. After the cleaning solution is used for cleaning, it can be recovered into the recovery tank 65 without leaking to the outside. In this manner, the recovery efficiency of the cleaning solution can be increased.

A first drying treatment step ST3 shown in FIG. 7 is then performed.

In the first drying treatment step ST3, dry air is supplied from the dry-air supply portion 76 of the drying treatment unit 52 shown in FIG. 3 to the cleaned surface 17 targeted for treatments through the supply path 80.

In this manner, the cleaning solution remaining on the surface 17 targeted for treatments is vaporized, so that the surface 17 targeted for treatments can be dried. The dry air used for the drying is recovered through the recovery paths 81 in a direction farther from the surface 17 targeted for treatments, that is, in the downward direction.

In this case, since the cooling units 77 and 78 cool the side walls 83, residual heat caused by heating of the side walls 83 due to the dry air is eliminated by the cooling. Therefore, the surface 17 targeted for treatments is not further adversely affected by the heat since the residual heat of the side walls 83 can be eliminated.

A lyophilic treatment step ST4 shown in FIG. 7 is then performed.

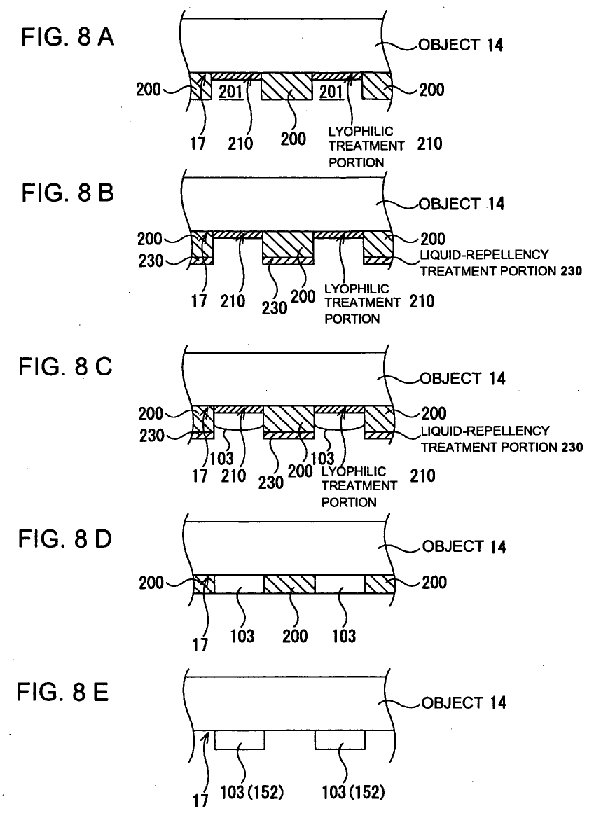

In FIG. 8(A), the pattern formation film 200 made of a photosensitive resin has been formed on the surface 17, which is targeted for treatments, of the object 14 through the above-described pretreatment step ST1. This pattern formation film 200 made of the photosensitive resin is provided with holes 201 in advance.

In the lyophilic treatment step ST4, the lyophilic treatment unit 53 shown in FIG. 4 forms lyophilic treatment portions 210 in the holes 201 of the pattern formation film 200 made of the photosensitive resin by O₂ plasma through the atmospheric-pressure plasma treatment. In the plasma discharge region 95 generated by the lyophilic treatment unit 53 shown in FIG. 4, excited active species of the reactant gas are generated. These excited active species form the lyophilic treatment portions (lyophilic films) 210 in the location of the holes 201 of the surface 17 targeted for treatments.

A liquid-repellency treatment step ST5 shown in FIG. 7 is then performed.

In the liquid-repellency treatment step ST5, the liquid-repellency treatment unit 54 shown in FIG. 5 forms liquid-repellency treatment portions 230 on the surface of the pattern formation film 200 made of the photosensitive resin by CF₄ plasma through the atmospheric-pressure plasma treatment, as shown in FIG. 8(B), for example. In this case, excited active species of the reactant gas are generated in the plasma discharge region 95A generated by the liquid-repellency treatment unit 54 shown in FIG. 5. These excited active species form the liquid-repellency treatment portions (liquid-repellent films) 230 on the surface of the pattern formation film 200 made of the photosensitive resin.

In this manner, the lyophilic treatment portions 210 shown in FIG. 8(A) and the liquid-repellency treatment portions 230 shown in FIG. 8(B) are sequentially formed on the side of the surface 17, which is targeted for treatments, of the object 14 through the atmospheric-pressure plasma treatment.

A liquid agent application treatment step ST6 shown in FIG. 7 is then performed.

In the liquid agent application treatment step ST6, a liquid agent 103 is applied to the lyophilic treatment portions 210, as shown in FIG. 8(C), for example. That is, the liquid agent 103 is filled in the holes 201. This liquid agent application treatment step ST6 is performed by the liquid agent application treatment unit 55 shown in FIG. 6. The liquid agent 103 is selectively applied to the surface 17 targeted for treatments, in particular to the holes 201 shown in FIG. 8(C), through the nozzle 101. This liquid agent 103 is formed on the lyophilic treatment portions 210. For example, this liquid agent 103 may be an agent in which an ITO fine powder having a particle diameter of 0.1 μm or less is dispersed in a solvent, an agent in which dibutyltin diacetate (DBTDA) and indium acetylacetate (InAA) are dissolved in an organic solvent, e.g., acetylacetone, or the like, when the liquid agent 103 is used as an ITO film for constituting a transparent electrode of a liquid crystal panel.

A second drying treatment step ST7 shown in FIG. 7 is then performed.

In the second drying treatment step ST7, dry air is supplied from the dry-air supply portion 76 shown in FIG. 3 to the surface 17 targeted for treatments. In this manner, drying of the liquid agent 103 on the surface 17 targeted for treatments is performed.

In the annealing treatment step ST8 shown in FIG. 7, the surface shown in FIG. 8(C) is subjected to an annealing treatment (firing and removal of the pattern formation film made of the photosensitive resin). In this manner, as shown in FIG. 8(D), a pattern composed of the liquid agent 103 and the pattern formation film 200 made of the photosensitive resin is formed. Subsequently, as shown in FIG. 8(E), the pattern formation film 200 made of the photosensitive resin is removed, so that a pattern of a display electrode 152 made of the liquid agent 103 is formed.

In this manner, the surface 17, which is targeted for treatments, of the object 14 shown in FIG. 1 can be subjected to continuous plural types of treatments combined at will by the use of the units from the cleaning treatment unit 51 to the annealing treatment unit 57.

Since the combination of the plural types of treatment units can be changed or any type can be added, when the surface, which is targeted for treatments, of the object is subjected to plural types of treatments, the manner of continuous treatment of the continuous-treatment apparatus can be easily and reliably changed or added to in accordance with the type of object.

The object carrier 20 can carry the object 14 along the carrying direction T while the surface 17 targeted for treatments is facing downward. Consequently, since the surface targeted for treatments is carried while facing downward, even when the liquid is supplied to the surface 17 targeted for treatments, the excess liquid thereon can be easily removed from the surface targeted for treatments by being allowed to fall, so that the excess liquid is prevented from remaining on the surface targeted for treatments. In this manner, the liquid has no negative effect on a downstream treatment of the surface targeted for treatments and, therefore, the surface targeted for treatments can smoothly be subjected to continuous plural types of treatments.

In the embodiment shown in FIG. 1, the surface 17 targeted for treatments can be subjected to the cleaning treatment, the drying treatment, the lyophilic treatment, the liquid-repellency treatment, the liquid agent application treatment, the drying treatment, and the annealing treatment in that order. As a matter of course, without being limited, the surface 17 targeted for treatments may be subjected to the cleaning treatment, the drying treatment, the liquid-repellency treatment, the lyophilic treatment, the liquid agent application treatment, the drying treatment, and the annealing treatment in that order.

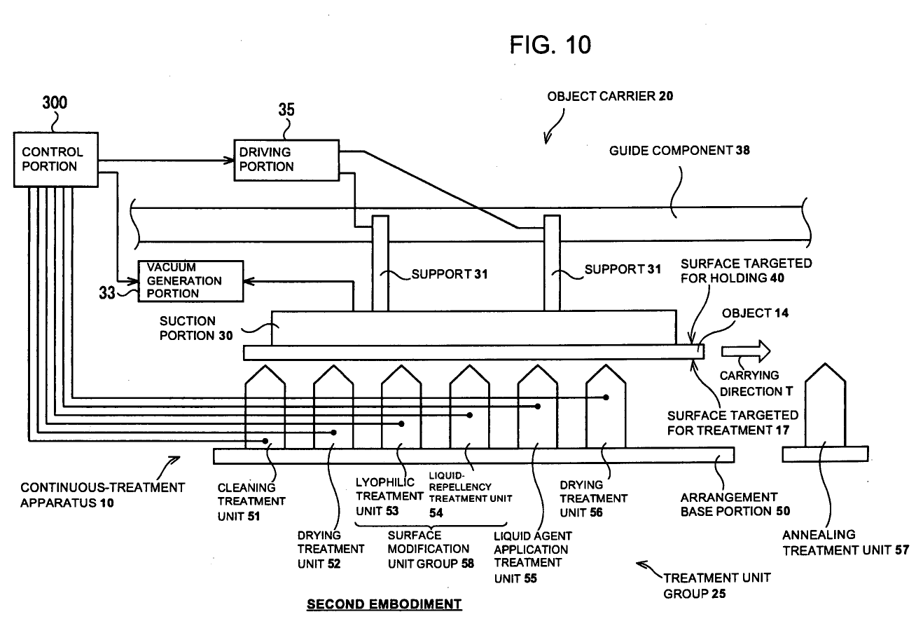

In a second embodiment of the present invention shown in FIG. 10, the last annealing treatment unit 57 is separately disposed outside of the treatment unit group 25. That is, the annealing treatment unit 57 is separately disposed further downstream from the treatment unit group 25 in the carrying direction T.

In this manner, the entire surface 17 targeted for treatments may be subjected to the cleaning, drying, lyophilic, liquid-repellency, liquid agent application, and drying treatments and, thereafter, the whole surface 17 targeted for treatments may be subjected to the annealing treatment at the same time through the use of one relatively large annealing treatment unit 57, for example.

In the embodiment of the continuous-treatment apparatus of the present invention, the units from the cleaning treatment unit 51 to the annealing treatment unit 57 can be removably arranged in a line on the arrangement base 50. Consequently, the locations of the treatment units in the carrying direction T can be interchanged between the upstream side and the downstream side, if necessary. It may be desirable to change the arrangement depending on the desired content of the treatment of the surface 17, which is targeted for treatments, of the object 14.

If necessary, with respect to the treatment unit group 25, any unnecessary treatment unit may be removed and/or any other necessary treatment unit may be added at will.

The object 14 is linearly transferred along the carrying direction T by the object carrier 20. In this case, the object 14 can be carried along the treatment units 51 to 57 of the treatment unit group 25, arranged in a line. Consequently, when seven known large treatment apparatuses, for example, are arranged, conventionally a carrying mechanism must be disposed in every location between one treatment apparatus and the next treatment apparatus in order to pass the object therebetween.

However, in the embodiment of the present invention shown in FIG. 1, by disposing one object carrier 20, the surface 17 targeted for treatments is allowed to face the plural types of treatment units 51 to 57, and the surface 17 targeted for treatments can be subjected to each treatment sequentially and continuously.

Since the surface 17 targeted for treatments is held and carried while facing the treatment unit group 25 in a downward direction, when, for example, the surface 17 targeted for treatments is cleaned with the cleaning treatment unit 51, an excess cleaning solution is allowed to fall by gravitation, so that the excess cleaning solution is removed from the surface 17 targeted for treatments without remaining thereon. The same holds true for the liquid agent application treatment unit 55. Since an excess liquid agent is allowed to fall by gravitation, the adhesion of the excess liquid agent can easily be prevented.

If the surface 17 targeted for treatments is located on the top side, excess amounts of the cleaning solution and the liquid agent may remain on the surface 17 targeted for treatments and, furthermore, it becomes difficult to apply the liquid agent to the surface 17 targeted for treatments by a so-called slit coating method shown in FIG. 6.

As described above, in the embodiment of the continuous-treatment apparatus of the present invention, after the surface 17 targeted for treatments is subjected to the pretreatment step ST1 shown in FIG. 7, the object 14 is suctioned by the suction portion 30 so that the surface 17 targeted for treatments is located on the bottom side as shown in FIG. 1.

In the embodiment of the continuous-treatment apparatus of the present invention, since each of the treatment units 51 to 57 are arranged in a line, the length of a production line for treating the object 14 can be minimized and, therefore, the tact time can be reduced.

Since the object 14 can be continuously treated, the processes after modification of the surface 17 targeted for treatments are stabilized and, therefore, an increase in yield can be expected.

Since the surface 17, which is targeted for treatments, of the object 14 is continuously treated, a cleaning step may not always be disposed between one treatment and the next treatment.

The continuous-treatment apparatus 10 of the present invention may be referred to as an apparatus for complex processing or the like.

The object 14 is upsized when used for, e.g., a large liquid crystal display element. In the case where such a large object 14 is prepared, since the surface 17 targeted for treatments can be treated by each of the treatment units continuously, a significant increase in the productivity and reduction of the load on the equipment can be realized.

Since the continuous-treatment apparatus of the present invention can perform all processes at atmospheric pressure or at a pressure near atmospheric pressure, the energy efficiency can be significantly increased compared with that in the treatments performed in a vacuum.

In the continuous-treatment apparatus of the present invention, each type of treatment unit is not limited to one unit and, for example, at least two units of some type may be disposed side by side so that the treatment capacity thereof agrees with the treatment capacity of the other type of treatment unit.

Since the combination of plural types of treatment units can be changed or added to, the function of the continuous-treatment apparatus can be flexibly changed in response to changes in the process. Examples of treatments performed by treatment units include a cleaning treatment, a draining treatment, a lyophilic treatment, a liquid-repellency treatment, an ashing treatment, an etching treatment, a plasma polymerization treatment, a liquid film formation treatment, a drying treatment, and an annealing treatment, and the combination of these treatments can be changed, added to, or interchanged.

In the continuous-treatment apparatus of the present invention, each treatment unit is compatible with other types of treatment units with respect to attachment. For example, a treatment unit can be replaced with, e.g., an ink-jet coating unit.

In the embodiment of the continuous-treatment apparatus of the present invention, the object is carried while the surface targeted for treatments is facing downward, and each treatment unit is arranged to face the surface targeted for treatments facing downward.

However, the continuous-treatment apparatus of the present invention is not limited to this. As a matter of course, the object may be carried by an object carrier while the surface targeted for treatments is facing upward, and each treatment unit may be arranged in the location above the object along the carrying direction of the object in order to face the surface targeted for treatments facing upward.

In the present invention, the object is, for example, a glass substrate of a large liquid crystal display element.

However, the continuous-treatment apparatus of the present invention is not limited to this, and can be applied to substrates used in the preparation of other types of devices, as a matter of course. The types of objects may include a substrate of a so-called large organic LED (light-emitting diode), as well.

The present invention is not limited to the above-described embodiments, and any modification can be performed within the scope of claims.

With respect to each configuration of the above-described embodiments, a part thereof may be omitted, or any combination different from those in the above description may be performed.

What is claimed is:

1. A continuous-treatment apparatus for subjecting a surface, which is targeted for treatments, of an object to continuous plural types of treatments, comprising:
an object carrier selectively holding the object and carrying the object along a carrying direction; and
plural types of treatment units which are arranged side by side along the carrying direction of the object and which subject the surface, which is targeted for treatments, of the object to sequential different treatments at atmospheric pressure or at a pressure near atmospheric pressure,
wherein, a combination of the plural types of treatment units may be changed at will and any desired type of treatment unit may be added.

2. The continuous-treatment apparatus according to claim 1, wherein the object carrier comprises:
a suction portion removably suctioning and holding a surface targeted for holding, which is opposite to the surface targeted for treatments, of the object;
a guide component guiding the suction portion in the carrying direction; and
a driving portion transferring the suction portion along the guide component.

3. The continuous-treatment apparatus according to claim 1, wherein the object is carried by the object carrier while the surface targeted for treatments of the object is facing downward, and the plural types of treatment units are operated upward to treat the surface, which is targeted for treatments, of the object.

4. The continuous-treatment apparatus according to claim 3, wherein the plural types of treatment units comprise a cleaning treatment unit, a drying treatment unit, a surface modification treatment unit, a liquid agent application treatment unit, and an annealing treatment unit.

5. The continuous-treatment apparatus according to claim 1, wherein the object comprises a substrate of a display device.

6. A continuous-treatment method for subjecting a surface, which is targeted for treatments, of an object to continuous plural types of treatments, the method comprising:
subjecting the surface, which is targeted for treatments, of the object to sequential different treatments at atmospheric pressure or at a pressure near atmospheric pressure through the use of plural types of treatment units arranged side by side along a carrying direction of the object while the object is held and the object is carried along the carrying direction, wherein the combination of the plural types of treatment units may be changed at will and any desired type may be added in accordance with the type of the object.

7. The continuous-treatment method according to claim 6, wherein the object is carried by the object carrier while the surface, which is targeted for treatments, is facing downward, and the plural types of treatment units are operated upward to treat the surface, which is targeted for treatments, of the object.

8. The continuous-treatment method according to claim 7, wherein the plural types of treatment units comprise a cleaning treatment unit, a drying treatment unit, a surface modification treatment unit, a liquid agent application treatment unit, and an annealing treatment unit.

9. A continuous-treatment apparatus comprising:
an object carrier selectively holding an object and carrying the object along a carrying direction, the object carrier holding the object so that a surface of the object which is targeted for treatments faces downward; and
a plurality of different types of treatment units arranged side by side in a line along the carrying direction of the object, the plurality of different types of treatment units subjecting the surface of the object which is targeted for treatments to sequential different upwardly directed treatments at or near atmospheric pressure,
wherein, a combination of treatment units constituting the plurality of different types of treatment units may be changed at will and any desired type of treatment unit may be added.
